(19) United States
(12) Patent Application Publication
(10) Pub. No.: US 2009/0120881 A1
(43) Pub. Date: May 14, 2009

(54) TREATMENT BLENDS FOR REMOVING METALS FROM WASTEWATER, METHODS OF PRODUCING AND PROCESS OF USING THE SAME

(76) Inventor: Sam Fanday, Chatsworth, CA (US)

Correspondence Address: CHRISTIE, PARKER & HALE, LLP, PO BOX 7068, PASADENA, CA, 91109-7068, US

(21) Appl. No.: 12/270,844

(22) Filed: Nov. 13, 2008

Related U.S. Application Data
(60) Provisional application No. 60/987,749, filed on Nov. 13, 2007.

(51) Int. Cl. C02F 1/52; C02F 5/08

(52) U.S. Cl. 210/725; 210/727; 252/175

(57) ABSTRACT

Treatment blends for removing metals from wastewater, method of producing and process of using the same. Treatment of industrial wastewater streams relate to the use of a pretreatment blend and a treatment blend, which remove heavy metals in industrial processes. The aqueous pretreatment blend comprises: 1) ferrous sulfate heptahydrate, 2) aluminum sulfate, 3) 85% phosphoric acid, and 4) coagulant. The aqueous treatment blend, which can be used in conjunction with or independent of the pretreatment blend comprises: 1) calcium hydroxide, 2) trimercapto-s-triazine 3) calcium hypochlorite, 4) sodium hydroxide, and 5) coagulant.

### CROSS-REFERENCE TO RELATED APPLICATION

This application claims priority to and the benefit of U.S. Provisional Patent Application No. 60/987,749, filed Nov. 13, 2007 the entire contents of which are incorporated herein by reference.

### FIELD OF INVENTION

The present invention relates to the field of treating an industrial wastewater stream, more specifically, one or more embodiments relate to removing heavy metals from wastewater.

### BACKGROUND OF THE INVENTION

Wastewater arising from processes such as plating, metal surface treatment, printed circuit board manufacture, semiconductor manufacture, incineration residue treatment, metal-contaminated soil improvement and so on may contain heavy metals, which if discharged to a municipal waste system can be very detrimental to the environment. These wastewater streams may contain any number of contaminants, including heavy metals, organic wastes, and inorganic wastes. Heavy metals such as copper, iron, gold, lead, nickel, silver, tin, zinc, chromium, cadmium, and arsenic, for example, can be highly toxic. They can also make the wastewater corrosive, inflammable, and even explosive.

As a result, many plants, as required by strict regulations, implement pollution prevention programs that cover a broad range of pollution control methods. For example, one pollution control scheme employed by a plating facility includes drag-out and rinse water reduction, chemical recovery from rinse waters, bath maintenance, material substitution, and more importantly, removal of heavy metals from wastewater streams prior to discharging them to municipal wastewater systems.

Traditional methods of treating wastewater streams that contain different metal contaminants involve multiple processes. For example, for a chromium contained wastewater stream, it is required to segregate the chromium into a separate waste stream to reduce the chromium from its hexavalent form to the trivalent state, which then can subsequently be precipitated as chromium hydroxide by additions of alkali. Similarly, a cyanide contained wastewater stream requires segregation of the component, and further oxidization of the toxic cyanides to harmless carbon and nitrogen compounds. Also, a combined metals laden wastewater stream requires removal of the metal precipitates by multiple cycles of pH adjustment and extraction as each metal has a different precipitation threshold at different pH levels.

Accordingly, there is a need to remove all contaminants, particularly heavy metals in industrial process wastewater to reduce processing and treatment time, as well as to eliminate the need of having multiple equipment and/or monitoring systems for treating separate contaminants.

### SUMMARY OF THE INVENTION

An aspect of an embodiment of the present invention is directed toward the use of two chemical blends that can be used separately or in combination to remove heavy metals in industrial processes. The chemical blend(s) will precipitate heavy metals at pH levels that normal solubility curves would say is impossible. In addition, the chemical blend(s) will reduce treatment time by having faster reactions, reduce the number of chemicals needed thereby reducing the steps to break complexing metals, reduce the sludge volume generated by traditional chemicals, eliminate dithiocarbamate (DTC) and the offensive odor associated with it, and overall remove heavy metals more effectively and at a lower cost.

Another aspect of an embodiment of the present invention is directed toward an acidic chemical blend that can be used as a pretreatment blend and an alkaline chemical blend that can be used as a treatment blend. The treatment blend can be used alone or in conjunction with the pretreatment blend.

In one embodiment, the treatment blend can be used to remove some or all of the metals in the wastewater and at the same time reduce sludge volumes. In another embodiment, the treatment blend can be configured to remove 21 different types of metal or metal-alloys in one pass. Some of the examples of heavy metals include, but are not limited to, copper (Cu), nickel (Ni), zinc (Zn), chrome (Cr), and cadmium (Cd).

According to an embodiment of the present invention, there is provided a treatment blend consisting essentially of trimercapto-s-triazine, trisodium salt; 12.5% sodium hypochlorite; 50% caustic soda; and calcium hydrated lime in a ratio to the caustic soda ranging from more than 1 to about 3.14 by weight percent; two commercially available metal grabbers that in combination contribute about 0.5 to about 3.0 by weight percent, and two commercially available coagulates that in combination contribute about 0.5 to about 1.5 by weight percent

Another aspect of an embodiment of the present invention is directed toward a method of preparing a treatment blend comprising steps of adding water to a mixing tank with a turning mixer, mixing the calcium hydrated lime into the water and allowing a mixture with calcium hydrated lime to take place, adding trimercapto-s-triazine, trisodium salt into the mixture and allowing a mixture with trimercapto-s-triazine, trisodium salt to take place, adding caustic soda into the mixture and allowing a mixture with caustic soda to take place, adding sodium hypochlorite, and adding one or two coagulants.

Another aspect of an embodiment of the present invention is directed toward a pretreatment blend that includes: ferrous sulfate heptahydrate, aluminum sulfate, acid and a coagulant, wherein, the amounts of ferrous sulfate heptahydrate and aluminum sulfate are substantially the same. In one embodiment, the acid is a phosphoric acid, particularly, 85% phosphoric acid.

Another aspect of an embodiment of the present invention is directed toward a method of preparing a pretreatment blend comprising steps of: adding water to a mixing tank with a mixer, mixing the ferrous sulfate heptahydrate into the water, adding the aluminum sulfate, adding 85% phosphoric acid, and a adding coagulant.

Another aspect of an embodiment of the present invention is directed toward a process of treating wastewater using both the pretreatment and the treatment blends. The method comprising steps of: measuring the flow rate of the wastewater in a pipeline feeding from an influent water tank; measuring the pH of the wastewater in the pipeline feeding from the influent water tank; administering a first pretreatment directly into the pipeline in an amount determined by a first calculation of the flow rate and the pH level; mixing the wastewater with the first pretreatment by a first inline static mixer; administering a second treatment blend directly into the pipeline in an amount determined by a second calculation of the flow rate and the pH level; mixing the wastewater with the first pretreatment and together with the second treatment by a second inline static mixer for metal precipitation. The flow rate of the wastewater affects the pH of the wastewater, specifically in regards to duration or residence time for the pretreatment blend and treatment blend to achieve the pH of the wastewater to bring about precipitation. Thus, knowing the flowrate and the pH of the wastewater is important consideration for the administration of the pretreatment blend and treatment blend to achieve the condition for the precipitation of the heavy metal ions and other unwanted molecules.

The use of the treatment blend according to an embodiment of the present invention eliminates the need of having complicated flow and extraction processes with multiple chemical treatments. Accordingly, wastes can be mixed without a need to have separate waste streams. In addition, the use of the treatment blend does not produce a typical sulfur odor as compared to other conventional processes.

### BRIEF DESCRIPTION OF THE DRAWINGS

FIG. 1 is a schematic of the physical apparatus that is used to carry out the process of treating wastewater in the present invention showing tanks for a pretreatment blend and three treatment blends.

FIG. 2 1 is another schematic of the physical apparatus that is used to carry out the process of treating wastewater in the present invention showing tanks for a pretreatment blend and two treatment blends.

FIG. 3 is an illustration of the physical apparatus that is used to carry out the process of treating wastewater with a precipitation tank.

FIG. 4 is another illustration of the physical apparatus that is used to carry out the process of treating wastewater without a precipitation tank.

### DETAILED DESCRIPTION

The present invention relates to a treatment blend that can be used to remove dissolved heavy metals from aqueous industrial waste water such as, industrial plating rinse waters, metal deburring waste water, electronic circuit board waste water, pharmaceutical wastewater, and even municipal wastewater, potable water, makeup water, groundwater, surface water, storm water, or combinations thereof.

In one embodiment the treatment does not contain sulfides or sodium DTC. As a result, it does not produce an objectionable odor as compared to other traditional treatment solutions.

In one embodiment, the treatment blend comprises trimercapto-s-triazine, trisodium salt (or 1,3,5-triazine-2,4,6(1H,3H,5H)-trithione, trisodium salt), hereinafter “triazine/trisodium” which is a cyclic nitrogen/sulfur compound, that neither reacts with acids to form flammable carbon disulfide, nor produces it as a by-product of its reaction with heavy metal ions.

In one embodiment, the treatment blend further comprises coagulants with at least one organic precipitant and a sodium salt. The treatment blend further comprises an alkaline blend of hydroxide ions, which are generated from a catalytic reaction from hydroxides, particularly metal hydroxides such as magnesium hydroxide, sodium hydroxide, and/or calcium hydroxide, for example.

According to an aspect of an embodiment of the present invention, the catalytic reaction occurs as the sodium salt react with the triazine/trisodium. To quench the overactive chemical reaction of the hydroxide radicals a suppressant in the form of hypochlorite ions may be used. Examples of hypochlorite ions include, but are not limited to, calcium hypochlorite or sodium hypochlorite. Sodium hypochlorite is a strong oxidizing agent. It tends to aid in cyanide destruction as well as the removal of dyes and pigments. In one embodiment, an aqueous solution of sodium hypochlorite at about 12.5% to about 15% (or 12.5% to 15%) is used.

The treatment blend of the present invention can effectively remove heavy metals, including 21 identified types of metal or metal-alloys, in one treatment step. It can remove cation and anion metals effectively and produce a clear and non-colored supernatant.

Also unlike other treatment processes, where multiple cycles, particularly multiple pH adjustment cycles are required to remove metals from acidic and alkaline waste water, the current invention can remove metals from both acidic and alkaline waste water in one cycle, with only one pH adjustment. In one embodiment, the treatment blend is added until a pH level (that can be predetermined) is reached.

According to another aspect of an embodiment of the present invention, the treatment blend can remove zinc without raising the pH of the waste water to approximately 9.5. In another embodiment, the treatment blend can remove cadmium without raising the pH of the waste water to approximately 11.

Also, unlike other processes, where multiple cycles are required to remove highly toxic hexavalent chromium (CR⁶⁺) from waste water by reducing CR⁶⁺ to trivalent chromium (CR³⁺) in the form of chromium sulfates by using a sulfate treatment, for example, the treatment blend of the present invention can remove CR⁶⁺ in one pass without an intermediate step. Accordingly, the treatment blend of the present invention can remove heavy metal ions regardless of the valence in one cycle. Further, it can also remove all heavy metals in one cycle even in the presence of interfering agents such as ammonia/ammonium ions, total kjedhal nitrogen (TKN), thiourea, meta-cyanide, cyanidelcyanate complexes, citratelcitric acid, sulfates/sulfites, surfactants, ethylenediaminetetraacetic acids (EDTA), pesticides, organo-metallic complexes, and/or industrial soaps.

In one embodiment, the treatment blend is also effective in precipitating non-metals such as selenium or fluorine in a form of hydrogen fluoride, for example. It is also effective in precipitating semi-metals such as antimony (Sb), Boron (B) or Arsenic (As) occurring in the cationic/anionic forms as Arsenate/Arsenite ions.

In another embodiment, the treatment blend is also effective in precipitating transition metals such as Titanium (Ti), Vanadium, (V), Cobalt (Co), Ion (Fe), Manganese (Mn), Chromium (Cr), Nickel (Ni), Copper (Cu), Zinc (Zn), Molybdenum (Mo), Palladium (Pd), Silver (Ag),Mercury (Hg), Cadmium (Cd), Gold (Au), Platinum (Pt), and/or combinations thereof. Metals such as Barium (Ba), Lithium (Li), Aluminum (Al), Tin (Sn), Lead (Pb), and Bismuth (Bi). Even amphoteric Zinc (Zn) can also be eliminated.

The unique characteristic of the treatment blend allows multiple waste streams with multiple heavy metal contamination to be combined in one tank for one treatment cycle unlike other traditional processes where multiple treatments are needed. In one embodiment, a chemical reaction of the treatment blend with a waste water stream has a very short reaction time and requires short retention time in the tank, usually less than one minute, therefore quick turn around time can be realized.

In another embodiment, the treatment blend can be administered in an automated manner without constant monitoring yet will remove heavy metals to levels that meet or exceed metal discharge limit requirements. According to another embodiment, the resulting sludge is 20% to 50% less in volume than traditional methods. The sludge is denser, forming large floes and easily dewatered. Therefore, pin floes or small mass of combined particles can be eliminated without the need of having a filter aid during a filtering process. The resulting sludge is highly stable and frequently passes the Toxicity Characteristic Leaching Procedure (TCLP) test.

According to an aspect of the invention, the treatment blend preferably comprises a mixture of five to seven different compounds. At least two of which are alkali treatment reagents, used for hydroxide precipitation. The treatment blend further includes one or two metal grabbers, sodium hypochlorite, and one or two different coagulants.

As for the two alkali treatment reagents, it is preferable that sodium hydroxide (i.e., NaOH, or, as it is commonly referred to, caustic soda or simply caustic) and lime (i.e., calcium hydroxide or calcium hydrated lime, Ca(OH)₂) are used.

Each alkali has advantages and disadvantages. For example, calcium hydrated lime has an advantage over caustic soda in terms of cost per unit of neutralizing capacity. It also induces a faster precipitation rate than caustic soda because of co-precipitation of calcium solids. Further, the settled sludge from the lime treatment is higher in solids content and is much more amenable to dewatering. On the other hand, lime takes longer to react in the neutralizer than caustic soda. Accordingly, the treatment blend of the present invention utilizes both calcium hydrated lime and caustic soda in a proportional amount. Preferably, the treatment blend has more calcium hydrated lime than caustic soda to take advantage of its fast precipitation rate and dewatering characteristic. In one embodiment, the ratio of calcium hydrated lime to caustic soda in a treatment blend is more than 1 by weight percent. In another embodiment, the ratio of calcium hydrated lime to caustic soda in the treatment blend can be about 2 to about 3 (or 3.14) by weight percent. Specifically, about 69 wt % of the total chemicals added in the treatment blend (excluding water) is calcium hydrated lime and about 22 wt % is caustic soda.

The first metal grabber used in the present invention are materials that may aid in the precipitation of heavy metals. They can be alkaline materials and may include a carbonate, and/or hydroxide, for example.

Sodium hypochlorite can also be used in the chemical blend. In one embodiment an approximate 12.5% aqueous solution of sodium hypochlorite is used. Sodium hypochlorite can be important in the treatment process. For example, if a colored, oxidizable material is present, sodium hypochlorite releases its oxygen to oxidize the material to a colorless compound, rendering a clear wastewater supernatant.

Lastly, the coagulants used in the chemical blends include organic coagulants that may contain calcium salt. These are organic coagulants, which bond and preclude the precipitated metals from dissolving back into the solution. They are effective for turbidity removal.

In one embodiment, the organic coagulant is a polymeric coagulant that contains calcium salt at less than 40% by weight. In another embodiment, the treatment blend further comprises a second cogaulant that is an organic precipitant.

The treatment blend of the present invention is preferably produced in a large batch. By way of illustration, a batch of over 2000 gallons of treatment blend is described herein.

First, 1500 gallons of water is poured into a large tank with a high speed mechanical mixer, the mixer is then turned on to allow mixing to begin.

The first ingredient, high calcium hydrated lime is then added. About 67 to 70 (or 70) 50-lb bags of the lime are poured in one at a time for proper dispersion. The powder is dispersed in the water for about five minutes to form a mixture.

The second ingredient, a first metal grabber, is then added. Preferably, about 12 gallons of the solution is used. The mixture is mixed for about 5 minutes to allow a new mixture with the first metal grabber to take place. In one embodiment, the addition of the first metal grabber is not necessary. Rather, only triazine/trisodium is used.

Next, the second metal grabber, triazine/trisodium is then added. Preferably, about 12 gallons of the solution is used. The mixture is then mixed for about 5 minutes to allow a new mixture with triazine/trisodium to take place.

The fourth ingredient, caustic soda is then added. Preferably, about 100 gallons of the 50% caustic soda solution is used. The mixture is then mixed for about 5 minutes to allow a new mixture with caustic soda to take place.

The fifth ingredient, sodium hypochlorite is then poured in. Preferably, about 10 gallons of 15% sodium hypochlorite is used. Without waiting for the typical five minutes of mixing, the next two coagulants can be added in right away. Preferably, 12 gallons of the fifth ingredient polymeric coagulant with calcium salt is added, followed by 4 gallons of the sixth polymeric coagulant containing organic precipitants.

Next, another 500 gallons of water is added. The treatment blend is then allowed to be mixed to attain a homogenous solution. Preferably for about one hour before the blend can be used or put away for storage.

The resulting treatment blend has a milky white color appearance. It is alkaline and has a pH range of about 11.5 to about 13.5 (or 11.5 to 13.5). The specific gravity of the treatment blend ranges from about 1.18 to about 1.94 (or 1.18 to 1.94), and has a boiling point and a freezing point at or about 217° F. and 42° F., respectively.

The resulting treatment blend preferably has approximately 74.194 wt % water, 17.807 wt % calcium hydrated lime, 0.566 wt % metal grabber, 0.499 wt % triazine/trisodium, 5.707 wt % caustic soda, 0.450 wt % sodium hypochlorite, 0.602 wt % Coagulite 300, and 0.175 wt % Coagulite EMR. According to various embodiments of the current invention, the resulting treatment blend has approximately 60-80 wt % water, 10-25 wt % calcium hydrated lime, 0.3-1.5 wt % metal grabber, 0.2-1.5 wt % triazine/trisodium, 5.0-10.0 wt % caustic soda, 0.2-1.5 wt % sodium hypochlorite, 0.2-1.0 wt % Coagulite 300, and 0.2-1.0 wt % Coagulite EMR. Varied amount of the ingredients may be used, preferably within a certain ratio range.

Although ingredients are added in the steps illustrated above, the order of one or more steps can be different. Also, while the present invention has been described in connection with certain ranges, it is to be understood that the invention is not limited to the disclosed herein, but, on the contrary, is intended to cover various modifications and ranges, and equivalents thereof.

In another embodiment, the waste water is treated with a pretreatment blend prior to being treated with the treatment blend of the present invention. The use of the pretreatment blend enhances the effect of the treatment blend of the present invention. Accordingly, when the two blends are used together, even a more substantial amount of metals can be removed from the contaminated stream.

The use of the pretreatment blend is preferred when there is a presence of any of the complex and/or interfering agent. Agents such as ethylene-diamine-tetraacetic acid (EDTA), ammonia or ammonium group, Total Kjedahl Nitrogen (TKN) group, citrate group, thiourea, free-total cyanide complexes, or sulfate.

The pretreatment blend is an acidic blend of chemicals. It works in tandem with the treatment blend by breaking metals or removing metal ions from enmeshed organic or inorganic matrices. Such actions from the pretreatment makes it possible for the treatment blend to bind free metals and/or react with other metal ions to precipitate them from the solution. Accordingly, heavily contaminated streams, particularly laden with cyanide meta-complexes, free total meta-cyanide complexes, or transitional metal complexes such as Cu, Cd, Ni-EDTA, and/or other complexes, are preferably treated first with the pretreatment blend.

In one embodiment, the pretreatment blend comprises two types of metal sulfate. The sulfates react with soluble metals and other metals in the contaminated stream to produce insoluble precipitates or transform them to other more soluble forms by oxidizing their molecular chains and/or breaking their meta-organic bonds. The contaminated stream is then treated with the treatment blend, which binds the metal ions and precipitates them from the solution.

According to another embodiment, the pretreatment blend is a mixture of four chemicals, two sulfate type chemicals, an acid, and a coagulate. Preferably, the blend comprises ferrous sulfate-heptahydrate and aluminum sulfate in equal amounts, and more preferably that the aluminum sulfate is in a ground form. The sulfates tend to react with metal ions to form metal sulfates and sulfides, or with other chelated metals to form less soluble metals. Hence, as a pretreatment it is preferred that the majority of the chemicals (about 80 wt % or more) is metal sulfates.

According to various embodiments of the current invention, the resulting treatment blend has approximately 80-90 wt % metal sulfates (where the weight percent is based on the total weight of the chemicals added excluding water); 12-22 wt % acid; and 0.5-2 wt % coagulites. In one embodiment, about 35-45 wt % of the chemicals added is ferrous sulfate heptahydrate, and about 35-45 wt % of the chemicals added is aluminum sulfate. In another embodiment, about 82 wt % of the chemicals added comprises metal sulfates. In one embodiment, about 40-41 wt % of the chemicals added is aluminum sulfate, 40-41 wt % of the chemicals added is ferrous sulfate heptahydrate, and less than 20% of the chemicals added is acid. As for the third chemical, acid, 85% phosphoric acid is preferred.

Phosphoric acid is preferred as it is used to aid in the sulfate reaction, particularly in complex reactions to break down cyanide meta-complexes, free-total metal-cyanide complexes, and including, but is not limited to, transitional metal complexes such as Cu, Cd, or Ni-EDTA.

As for the fourth chemical, a polymeric coagulant is used. Preferably, a polymeric coagulant that comprises a cationic polyelectrolyte and a soluble salt. In the present embodiment, Coagulite 200 is preferred. This coagulant bonds with metal sulfates and sulfides and prevent them from dissolving into the solution should there be a shift in equilibrium of the wastewater.

The pretreatment blend of the present invention is preferably produced in a large batch. By way of illustration, a batch of over 2000 gallons of treatment blend is described herein.

First, 1500 gallons of water is poured into a large tank with a high speed mechanical mixer, the mixer is then turned on to allow mixing to begin.

The first ingredient, ferrous sulfate heptahydrate is to be added. Preferably 70 50-lb bags are added one at a time for proper dispersion. The power is allowed to disperse in the water for about five minutes to form a mixture.

The second ingredient, aluminum sulfate is then added. Preferably 70 50-lb bags are added one at a time for proper dispersion. The mixture is mixed for about 5 minutes to allow a new mixture with aluminum sulfate to take place.

Next, the third ingredient, acid is then added. Preferably, about 100 gallons of the 85% phosphoric acid is used. The mixture is mixed for about 5 minutes to allow a new mixture with phosphoric acid to take place.

After five minutes of mixing, the fourth ingredient is added. About 12 gallons of Coagulite 200 is used preferably. Then, 500 gallons of water is added. The mixture is then allowed to be mixed to attain a homogenous solution, preferably, for approximately another hour before use or put away for storage.

The resulting pretreatment blend has a greenish color appearance It is acidic and has a pH range of about 1.5 to about 2.5 (or 1.5 to 2.5). The specific gravity of the treatment blend ranges from about 1.93 to about 1.96 (or 1.93 to 1.96), and has a boiling point and a freezing point at or about 280° F. and 44° F., respectively.

The resulting pretreatment blend preferably, has approximately 66.13 wt % water, 13.89 Wt % ferrous sulfate, 13.89 wt % aluminum sulfate, 5.57 wt % phosphoric acid, and 0.52 wt % coagulant. Different amount of ingredients can be used but preferably a certain ratio range is maintained. It should be noted that the illustrated steps above can be done in a different order and different ranges for the compositions can used.

The treatment blend of the present invention is preferably used with the above mentioned pretreatment blend. The blends can be used in various applications for treating industrial wastewater. The blends can used to treat wastewater in a batch-wise process or in a in-line process in a continuous manner. Several exemplary embodiments disclosed herein illustrate the use and effectiveness of the blends.

### Treatment Process

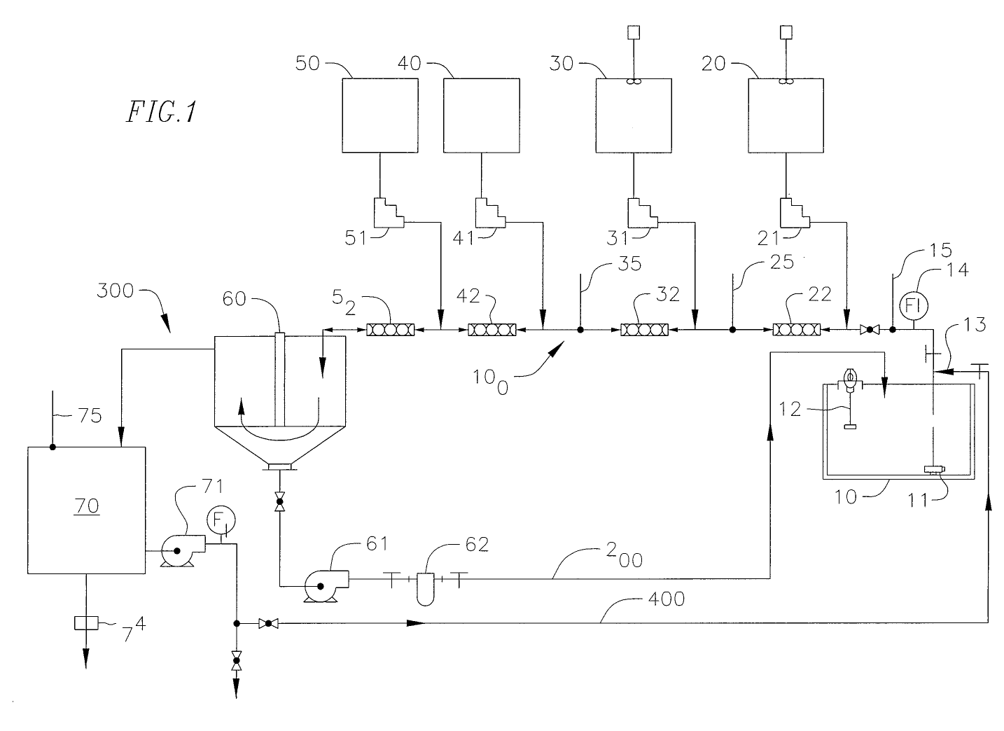

According to an aspect of an embodiment of the present invention as shown in FIG. 1, there is provided a continuous process for treating wastewater using one to four chemical blends. The process starts with an influent tank 10, which collects wastewater and feeds the wastewater into line 100 via a sump pump 11. At the sump pump discharge, there is provided a set of monitoring system, which may include a check valve 13, a flow meter 14, and an influent pH probe 15. The monitoring system further comprises a process control and an electronic interface which enable proper communication and relaying of information between sump pump 14, check valve 19, and amounts of chemical treatments down stream in the process.

In one embodiment, there is provided a high level float switch 12, which activates the sump pump 11 and treatment pumps 21, 31, 41, and 51 accordingly, when a certain level in the influent tank 10 is reached.

Referring back to FIG. 1, as the flow of wastewater from influent tank 10 flows through pipeline 100, flow meter 14 and influent pH probe 15 measure the wastewater flow rate and pH of the wastewater. The acquired information is then fed to a process control system, such as a process control software, which in turn, controls the flow rate of treatment pump 21 and subsequently treatment pumps 31, 41, and 51.

According to an aspect of the present invention, a first tank 20 comprises a pretreatment blend of the present invention and a second tank 30 contains a treatment blend of the present invention. Both the first and second chemical tanks, as well as a third tank 40 and a fourth tank 50, are preferably located above pipe line 100 to take advantage of gravitational flow.

According to an aspect of the present invention, the pretreatment flow rate from pretreatment pump 21 depends on the flow rate reading measured by flow meter 14 and pH reading measured by influent water pH probe 15.

In an embodiment of the present invention, an initial flow rate of pretreatment pump 21 can be automatically calculated based on a provided table of pH vs. influent flow rate variables and/or a correlation equation of pH and flow rate variables determined from prior bench scale and/or pilot studies.

Upon treatment with the pretreatment blend of tank 20, the wastewater treated with the pretreatment blend is mixed via an inline static mixer 22. The wastewater treated with the pretreatment blend is then measured for pH level by a pH probe 25.

Next, the wastewater is treated with a treatment blend of tank 30. The flow rate of treatment pump 31 which administers the treatment blend can be predetermined based on the initial flow rate of pretreatment pump 21. In an embodiment of the present invention, the flow rate of treatment pump 31 is directly proportional to the flow rate of pretreatment pump 21. In another embodiment of the present invention, the flow rate of treatment pump 31 can be calculated based on the downstream pH reading of pH probe 25 and the flow rate reading of flow meter 14. Alternatively, the flow rate of treatment pump 31 may also be calculated based on an upstream pH reading of pH probe 35 and the flow rate reading of flow meter 14.

According to an aspect of the present invention, the treated wastewater (treated by the pretreatment and treatment blends) has over 99.9% of the metals precipitated out of the wastewater, leaving a relatively clear to clear supernatant. The treated wastewater then can be fed to a clarifier 60 to allow the precipitated metals in the wastewater to settle and be removed from the clear supernatant.

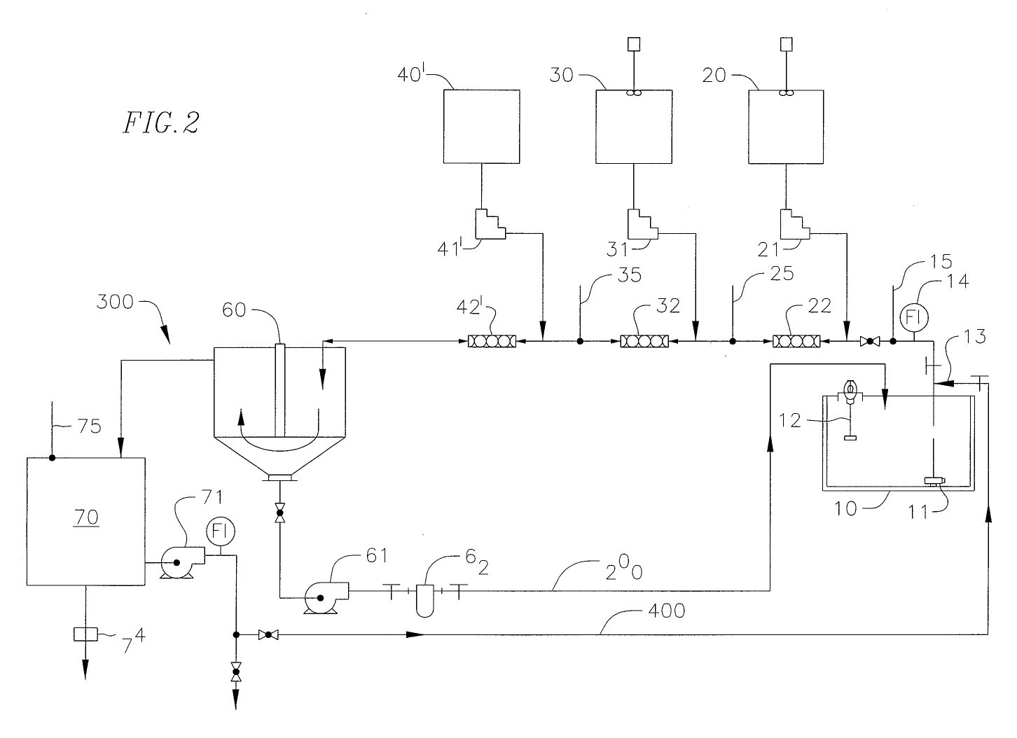

In one embodiment, the treated wastewater is further treated with a third treatment blend in tank 40′, FIG. 2. The third treatment blend is a polymeric solution. It can be used in both batch and continuous processes. In a continuous process, the third polymeric treatment is especially useful in facilitating pin flocs to settle and remove from the process.

According to an aspect of the present invention, the treated wastewater is further treated with a third treatment blend in tank 40 and a fourth treatment blend in tank 50, FIG. 1. In some cases, flocs of precipitated metals still remain in suspension. Therefore, more aggressive treatment may be needed to facilitate the flocs to combine into larger flocs and to settle out of the wastewater faster.

In one embodiment, the third treatment blend is a cationic emulsion comprising high molecular weight polymeric flocculant and/or coagulant aid. It has a milky white liquid color appearance. It is alkaline and has a pH range of about 9.5 to about 10.5 (or 9.5 to 10.5), a specific gravity of about 1.18, a viscosity measurement ranging from about 500 cps to about 1200 cps (or 500 cps to 1200 cps), and has a boiling point and a freezing point at or about 260° F. and 40° F., respectively.

The third treatment blend promotes larger flocs, faster settling time and denser sludge blankets with negligible pin floes by bonding and/or bridging the negative charged flocs in the treated wastewater.

According to an embodiment of the present invention and as shown by FIG. 1, the third treatment blend is again administered directly into pipeline 100 after the pH level reading is measured by pH probe 35. An amount of the third treatment blend administered by pump 41 may depends on a rate that may be predetermined based on the flow rate of flow meter 14 and the influent water pH reading of pH probe 15. Alternatively, the flow rate of treatment pump 41 may also be calculated based on the downstream pH level reading of pH probe 35, and/or an upstream effluent water pH reading of pH probe 75 and the flow rate reading of flow meter 14.

According to another aspect of an embodiment of the present invention, the fourth treatment blend is added to the treated wastewater. Similar to the third treatment blend, the fourth treatment blend also comprises a high molecular weight polymeric flocculant and/or coagulant aid and is highly charged. However, it is an anionic solution. It has a hazy white liquid color appearance. It is alkaline and has a pH range of about 9.5 to about 10.5 (or 9.5 to 10.5), a specific gravity of about 1.12, a viscosity measurement ranging from about 400 cps to about 1000 cps (or 400 cps to 1000 cps), and has a boiling point and a freezing point at or about 340° F. and 40° F., respectively.

The fourth treatment blend promotes even larger flocs, faster settling time and denser sludge blankets with negligible pin floes by bonding with the large floes created by the third treatment blend treatment.

According to an embodiment of the present invention and as shown by FIG. 1, the fourth treatment blend is again administered directly into pipeline 100. An amount of the fourth treatment blend administered by pump 51 may depends on a rate that may be predetermined based on the flow rate of flow meter 14 and influent pH reading of pH probe 15. Alternatively, the flow rate of treatment pump 51 may also be calculated based on downstream pH reading of pH probe 35, and/or the upstream effluent pH reading of pH probe 75, and the flow rate reading of flow meter 14.

As illustrated in the present embodiment of FIG. 1, the treated wastewater is then fed to clarifier 60 to allow the precipitated metals in the wastewater to settle. The precipitated metals forms a layer sediment at the bottom of clarifier 60 and a clear portion of supernatant water at the top.

At the top of the clarifier 60, there is provided a pipeline 300 for gravitational flow. Pipeline 300 may be tilted downward at a angle or directed vertically down to a receiver tank 70 that holds the clear supernatant or “effluent water”. The effluent water is monitored by effluent water pH probe 75 and may be discharged to a municipal sewer system if meets the local municipal standard. Sample port 74 is also provided to sample and test the discharged water for quality assurance.

In another embodiment, effluent pump 71 may be provided to further delivers the effluent water to a secondary and/or tertiary treatment process for further refining. Alternatively, effluent pump 71 may also recycle the effluent water back to influent tank 10 to provide a fresh supply of water.

At the bottom of the clarifier 60, there is provided a solid pump 61 that delivers the precipitated metal sludge and floes to a filtration media 62. The collected precipitated metals then can be disposed of and processed properly. A remaining filtrate/water in pipeline 200 that may contain precipitated metals may then be recycled back to influent tank 10 for retreatment.

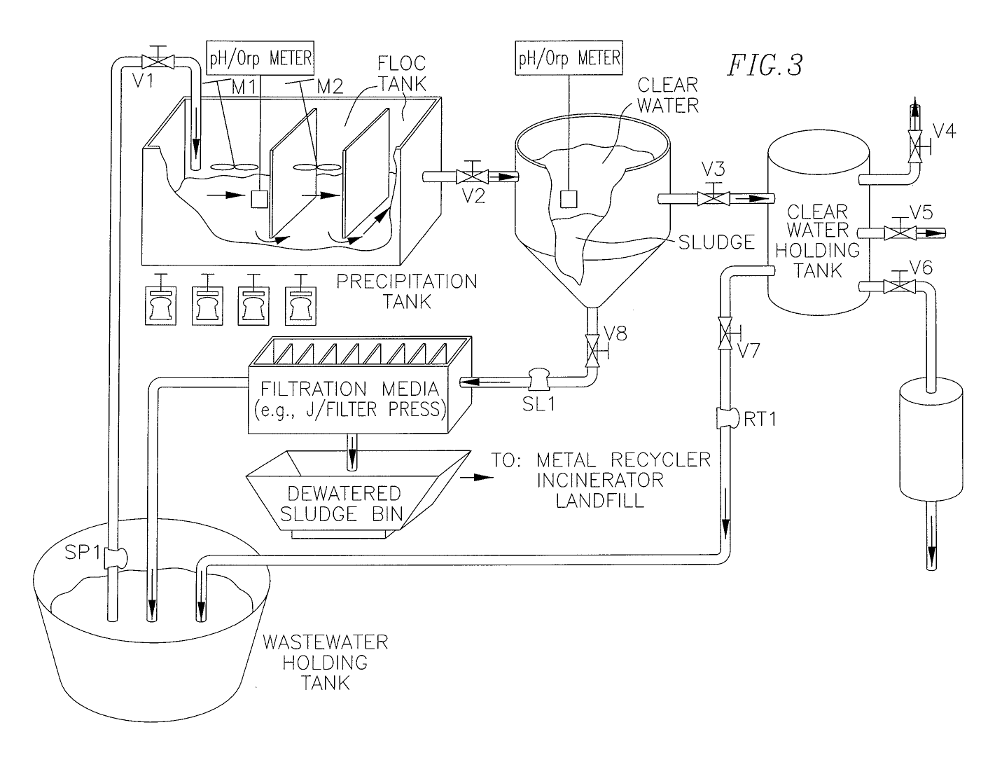

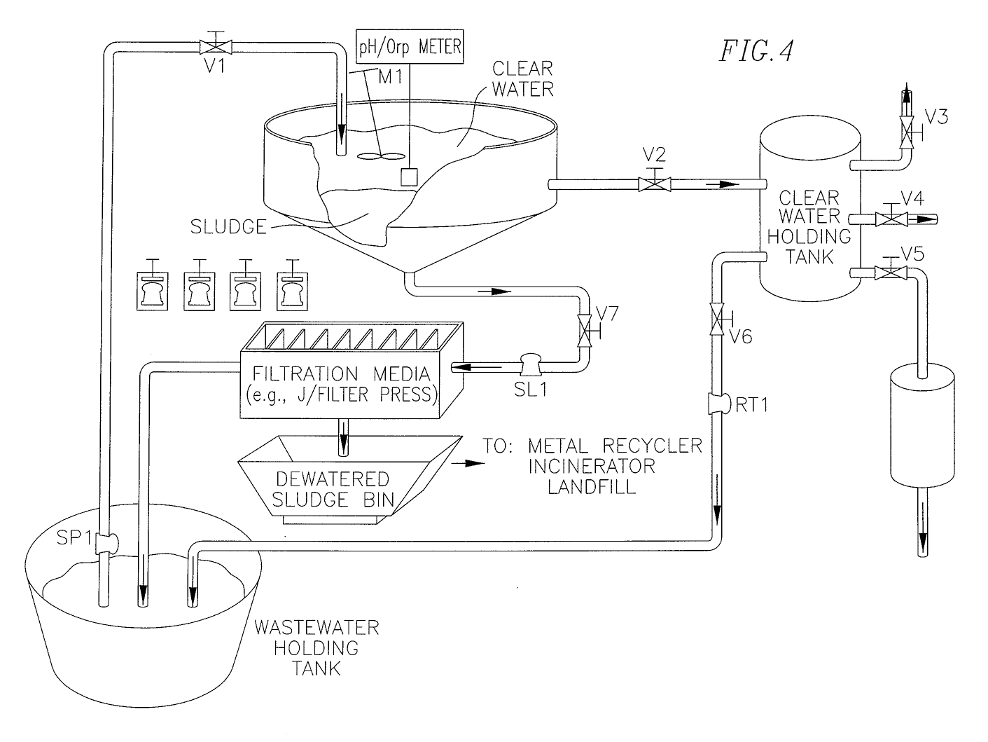

While particular methods have been described in connection with what is presently considered to be practical exemplary embodiments, it is to be understood that the invention is not limited to the disclosed embodiment, but, on the contrary, is intended to cover various modifications and equivalent arrangements, such as those shown in FIGS. 3 and 4, and equivalents thereof.

### EXAMPLE 1

An electroplating facility has an acidic waste stream with a pH of 3.5. The waste stream is high in hexavalent chrome, cadmium, copper, nickel, lead and zinc. It also contains various complexing agents, which require multiple pH adjustment cycles and various stages of treating chromate waste using conventional batch treatment process. Yet, the discharge wastewater cannot be brought into compliance with the local discharge limits. Upon treating the waste stream with the treatment blend of the present invention, multiple traditional steps are eliminated. The treatment using the blends of the present invention produces 20-50% less sludge. The floes are dense, large and highly dewaterable. Pin flocs are eliminated. No filter aid is required for the sludge in the filter press. The sludge produced is stable and passes the TCLP test.

Analytical lab test result using inductive-coupled plasma and graphite furnace techniques for the metal concentration measurements is as follows:

| | Before | After | |
|---|---|---|---|
| | treatment | treatment | % |
| Metal type | (ppm) | (ppm) | Removal |
| Hexavalent chrome | 683 | 0.03 | 99.996% |
| (Cr) | | | |
| Cadmium (Cd) | 366 | 0.02 | 99.995% |
| Zinc (Zn) | 32 | 0.001 | 99.997% |
| Copper (Cu) | 469 | 0.001 | 99.9998% |
| Lead (Pb) | 411 | 0.02 | 99.995% |
| Nickel (Ni) | 243 | 0.21 | 99.914% |
| Total | 2204 | 0.282 | 99.987% |

### EXAMPLE 2

Ground water at the landfill of a military base is contaminated with Arsenic (As) at a very low level of 22 ppb, Manganese (Mn) at 1.7 ppm and Iron (Fe) at 47 ppm, yet the contamination levels are higher than the discharge limits as required by the local county. Treatment of the contaminated ground water involves an in-line treatment process using the treatment blend of the present reaction in a continuous manner. The reaction time required is very short, hence short residence time and quick turn around time can be realized. Analytical lab test result for the metal concentrations before and after treatment is as follows:

| | Average before treatment | Average after treatment |
|---|---|---|
| Metal type | ppb (μg/L) | ppb (μg/L) |
| Arsenic (As) | 22 | 9 |
| Manganese (Mn) | 1.7 | 0.220 |
| Iron (Fe) | 47 | 0.375 |

### EXAMPLE 3

A metal refinery wastewater stream is treated using the treatment blend of the present invention. The test result before and after using the treatment blend is as follows:

| | Before treatment | After treatment |
|---|---|---|
| Metal type | ppm (mg/L) | ppm (mg/L) |
| Aluminum | 3,320 | 27 |
| Cadmium | 52 | 4.6 |
| Chromium | 144 | 0.5 |
| Copper | 6400 | 4.5 |
| Gold | 11.2 | 0.16 |
| Iron | 6400 | 0.81 |
| Lead | 204 | 0.64 |
| Nickel | 1320 | 0.80 |
| Palladium | 52 | 1.6 |
| Platinum | 24.4 | 9 |
| Silver | 10.8 | 0.51 |
| Zinc | 152 | 0.12 |

### EXAMPLE 4

An industrial laundry wastewater stream is treated using the treatment blend of the present invention. Like other treatments utilizing the treatment blend, the resulting waste water is clear, without color, and heavy metal contamination was virtually non-detectible. The test result before and after using the treatment blend is as follows:

| | Before treatment | After treatment |
|---|---|---|
| Metal type | ppm (mg/L) | ppm (mg/L) |
| Barium | 0.094 | Non-detect |
| Chromium | 0.18 | Non-detect |
| Copper | 0.098 | Non-detect |
| Manganese | 0.041 | 0.004 |
| Molybdenum | 0.018 | Non-detect |
| Nickel | 0.014 | Non-detect |
| Lead | 0.054 | Non-detect |
| Vanadium | 0.034 | Non-detect |
| Zinc | 0.61 | Non-detect |

What is claimed is:

1. A treatment blend for treating wastewater, comprising:
calcium hydrated lime;
trimercapto-s-triazine, trisodium salt;
caustic soda;
sodium hypochlorite; and
coagulant;
wherein the treatment blend is alkaline and is free of sulfides and sodium dithiocarbamate.

2. A treatment blend for treating wastewater, consisting essentially of:
calcium hydrated lime;
trimercapto-s-triazine, trisodium salt;
caustic soda;
sodium hypochlorite; and
coagulant.

3. The treatment blend of claim 2, wherein a ratio of calcium hydrated lime to caustic soda is more than 1 by weight percent.

4. The treatment blend of claim 2, wherein a ratio of calcium hydrated lime to caustic soda is about 3 by weight percent.

5. A method of producing the treatment blend of claim 2, comprising:
adding water to a mixing tank;
mixing the calcium hydrated lime into the water and allowing a mixture with calcium hydrated lime to take place;
adding trimercapto-s-triazine, trisodium salt into the mixture and allowing a mixture with trimercapto-s-triazine, trisodium salt to take place;
adding caustic soda into the mixture and allowing a mixture with caustic soda to take place;
adding sodium hypochlorite into the mixture; and
adding coagulants into the mixture.

6. The method of producing the treatment blend of claim 5, wherein a metal grabber is added into the mixture with calcium hydrated lime prior to the adding trimercapto-s-triazine, trisodium.

7. A treatment blend for treating wastewater, consisting essentially of:
calcium hydrated lime;
metal grabber;
trimercapto-s-triazine, trisodium salt;
50% caustic soda;
12.5% sodium hypochlorite; and
two coagulants,
wherein, the treatment blend has more calcium hydrated lime than caustic soda by weight percent.

8. A pretreatment blend for treating wastewater, comprising:
ferrous sulfate heptahydrate;
aluminum sulfate;
about 85% phosphoric acid; and
coagulant;
wherein the pretreatment blend is acidic.

9. A pretreatment blend for treating wastewater, consisting essentially:
two types of metal sulfates;
acid; and
a coagulant.

10. The pretreatment blend of claim 9, wherein the two types of metal sulfates are ferrous sulfate heptahydrate and aluminum sulfate in substantially equal amount.

11. The pretreatment blend of claim 9 is 80 wt % metal sulfates.

12. The pretreatment blend of claim 9, wherein the acid is a phosphoric acid.

13. The phosphoric acid of claim 12 with a concentration of about 85%,

14. The pretreatment blend of claim 9 is 20 wt % 85% phosphoric acid.

15. A method of producing the pretreatment blend of claim 9, comprising:
adding water to a mixing tank;
mixing the ferrous sulfate heptahydrate into the water and allowing a mixture to take place;
adding aluminum sulfate into the mixture and allowing a mixture with aluminum sulfate to take place;
adding about 85% phosphoric acid into the mixture and allowing a mixture with phosphoric acid to take place; and
adding coagulant into the mixture.

16. A method of treating wastewater comprising:
using the pretreatment blend of claim 9, and
using the treatment blend of claim 2.

17. A process for treating wastewater, comprising:
measuring a flow rate of the wastewater in a pipeline feeding from an influent water tank;
measuring a pH of the wastewater in the pipeline feeding from the influent water tank;
administering a first pretreatment directly into the pipeline in an amount determined by a first calculation of the flow and the pH;
mixing the wastewater with the first pretreatment by a first inline static mixer;
administering a second treatment blend directly into the pipeline in an amount determined by a second calculation of the flow rate and the pH level;
mixing the wastewater with the first pretreatment and the second treatment by a second inline static mixer;
wherein the first treatment blend consists essentially of ferrous sulfate heptahydrate, aluminum sulfate, acid and a coagulant, wherein, the amounts of ferrous sulfate heptahydrate and aluminum sulfate are substantially the same; and
wherein the second treatment blend consists essentially of two alkali treatment reagents; trimercapto-s-triazine, trisodium salt; sodium hypochlorite; and coagulant.

18. The alkali treament reagents of claim 17 are calcium hydrated lime and caustic soda.

19. The process for treating wastewater of claim 17, wherein there is only a single pH adjustment.

20. The process for treating wastewater of claim 17, wherein zinc can be removed without raising pH of the wastewater.

21. The process for treating wastewater of claim 17, wherein a heavy metal ion can be removed in a single cycle without an intermediate reducing step and in the presence of an interfering agent.

22. The heavy metal ion of claim 21 is a hexavalent chromium.

23. The interfering agent of claim 21 is selected from the group consisting of ammonia/ammonium ions, total kjedhal nitrogen, thiourea, meta-cyanide, cyanidelcyanate complexes, citratelcitric acid, sulfates, sulfites, surfactants, ethylenediaminetetraacetic acids, pesticids, organo-metallic complexes, and industrial soaps.

24. The process for treating wastewater of claim 17, wherein a metal, non-metal, a semi-metal, or a transition metal can be removed.

25. The process for treating wastewater of claim 17, wherein a metal grabber is used.
